(19) United States
(12) Patent Application Publication
(10) Pub. No.: US 2016/0186784 A1
(43) Pub. Date: Jun. 30, 2016

(54) Fluid Siphoning System

(71) Applicant: Daniel Mank, Mobile, AL (US)

(72) Inventor: Daniel Mank, Mobile, AL (US)

(21) Appl. No.: 14/587,960

(22) Filed: Dec. 31, 2014

(51) Int. Cl. F04F 10/00; B67D 7/58; B67D 7/04; F04F 3/00

(52) U.S. Cl. CPC F04F 10/00; F04F 3/00; B67D 7/58; B67D 7/04

(57) ABSTRACT

A fluid siphoning system includes a container that contains a fluid. A vehicle is provided that has a fuel tank. A housing is provided and a pump is positioned within the housing. The pump has an inlet and an outlet. The inlet and outlet extend outwardly through the housing. A suction hose is coupled to the inlet and is positionable within the container or the fuel tank to draw the fluid through the suction hose. A pressure hose is coupled to the outlet. The pressure hose is positionable within either of the container or the fuel tank to release the fluid into the container or the fuel tank. An actuator for actuating and de-actuating the pump is coupled to the housing and is electrically coupled to the pump.

### BACKGROUND OF THE DISCLOSURE

### Field of the Disclosure

The disclosure relates to siphoning devices and more particularly pertains to a new siphoning device for transferring fuel between a container and a fuel tank.

### SUMMARY OF THE DISCLOSURE

An embodiment of the disclosure meets the needs presented above by generally comprising a container that contains a fluid. A vehicle is provided that has a fuel tank. A housing is provided and a pump is positioned within the housing. The pump has an inlet and an outlet each extending outwardly through the housing. A suction hose is coupled to the inlet. The suction hose is positionable within the container or the fuel tank to draw the fluid through the suction hose. A pressure hose is coupled to the outlet. The pressure hose releases the fluid into the container or the fuel tank. An actuator is coupled to the housing. The actuator is electrically coupled to the pump. The actuator actuates and de-actuates the pump.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a fluid siphoning system according to an embodiment of the disclosure.

FIG. 2 is a perspective view of an embodiment of the disclosure.

FIG. 3 is a front view of an embodiment of the disclosure.

FIG. 4 is a right side view of an embodiment of the disclosure.

FIG. 5 is an in-use view of an embodiment of the disclosure.

### DESCRIPTION OF THE PREFERRED EMBODIMENT

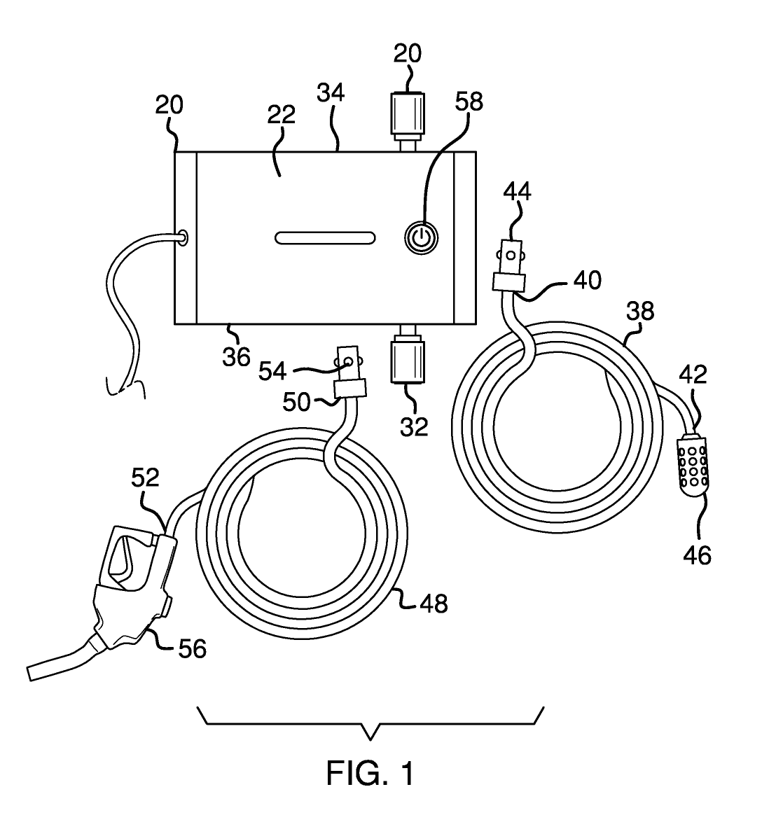

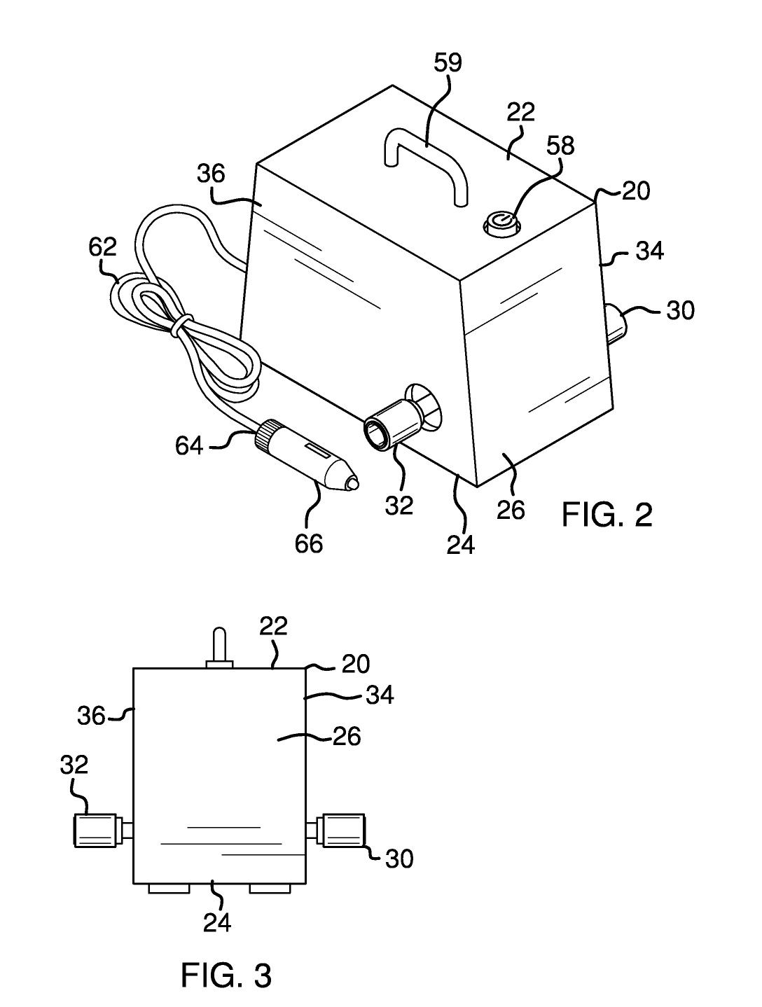

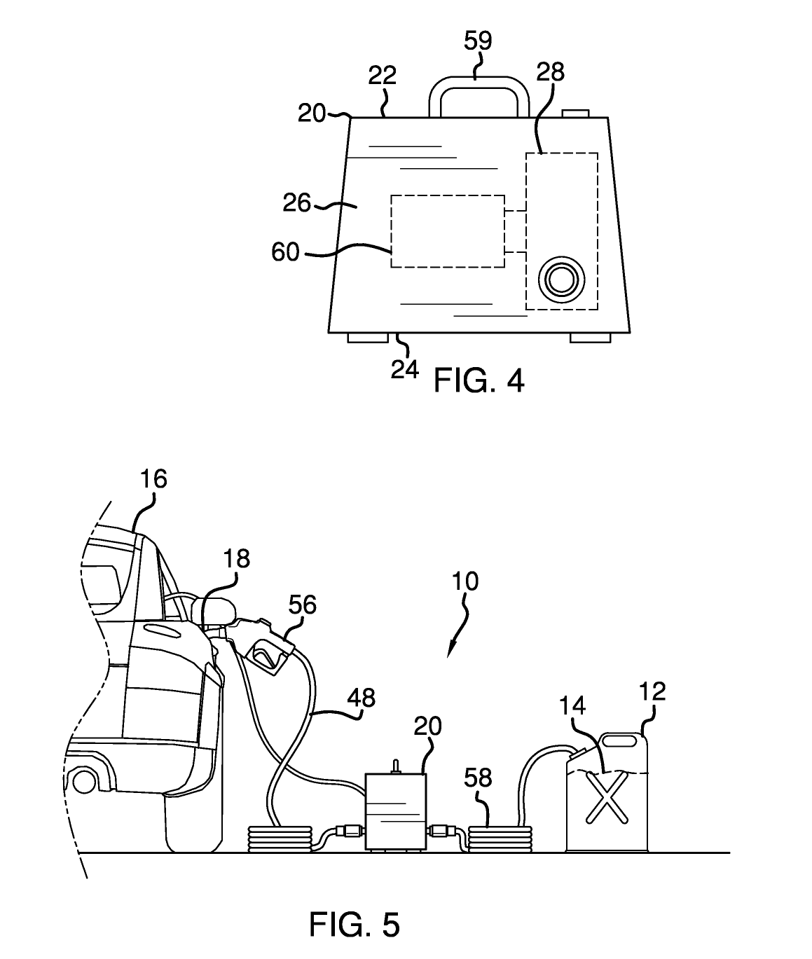

With reference now to the drawings, and in particular to FIGS. 1 through 5 thereof, a new siphoning device embodying the principles and concepts of an embodiment of the disclosure and generally designated by the reference numeral 10 will be described.

As best illustrated in FIGS. 1 through 5, the fluid siphoning system 10 generally comprises a container 12. The container 12 contains a fluid 14. The fluid 14 may be gasoline or the like. A vehicle 16 has a fuel tank 18 and the vehicle 16 may be a passenger vehicle or the like.

A housing 20 is provided that has top wall 22, a bottom wall 24 and a peripheral wall 26 extending therebetween. A pump 28 is positioned within the housing 20. The pump 28 has an inlet 30 and an outlet 32. The inlet 30 and outlet 32 each extend outwardly through the housing 20. The pump 28 may be a fluid pump or the like. The inlet 30 extends through a first lateral side 34 of the peripheral wall 26. The outlet 32 extends outwardly through a second lateral side 36 of the peripheral wall 26.

A suction hose 38 has a first end 40 and a second end 42. The first end 40 has a first coupler 44 attached thereto. The first coupler 44 engages the inlet 30 such that the pump 28 creates suction in the suction hose 38. The second end 42 has a screen 46 coupled thereto that is positionable within the container 12 or the fuel tank 18 to draw the fluid 14 through the suction hose 38. The screen 46 filters the fluid 14.

A pressure hose 48 has a first end 50 and a second end 52. The first end 50 of the pressure hose 48 has a second coupler 54 coupled thereto. The second end 52 has a valve 56 coupled thereto. The second coupler 54 engages the outlet 32 such that the pump 28 creates pressure in the pressure hose 48.

The pump 28 urges the fluid 14 into the pressure hose 48 when the screen 46 is positioned within the fluid 14. The valve 56 is actuatable to release the fluid 14 from the valve 56 into the container 12 or the fuel tank 18. An actuator 58 is coupled to the housing 20. The actuator 58 is electrically coupled to the pump 28. The actuator 58 actuates and de-actuates the pump 28. The actuator 58 may be positioned on the top wall 22. A handle 59 is provided. The handle 59 is coupled to the top wall 22. The handle 59 may be gripped to carry the housing 20.

A power supply 60 is coupled to the housing 20. The power supply 60 is electrically coupled to the actuator 58. The power supply 60 comprises a cord 62 extending outwardly from the peripheral wall 26. The cord 62 has a distal end 64 with respect to the housing 20. The distal end 64 has a plug 66 electrically coupled thereto. The plug 66 may be electrically coupled to the vehicle 16.

In use, the screen 46 is positioned within the fluid 14 in order to transfer the fluid 14 out of the container 12 or the fuel tank 18. The valve 56 is positioned in either the fuel tank 18 or the container 12 to deposit the fluid 14. The assembly 10 allows the fluid 14 to be transferred without spilling the fluid 14 or otherwise wasting the fluid 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid siphoning system comprising:
a container containing a fluid;
a vehicle having a fuel tank;
a housing;
a pump positioned within said housing, said pump having an inlet and an outlet, said inlet and outlet extending outwardly through said housing;
a suction hose coupled to said inlet, said suction hose being positionable within either of said container or said fuel tank, said suction hose drawing fluid when said pump is turned on; and
a pressure hose coupled to said outlet, said pressure hose being positionable into either of said container or said fuel tank, said pressure hose releasing the fluid when said pump is turned on; and
an actuator coupled to said housing, said actuator being electrically coupled to said pump, said actuator actuating and de-actuating said pump.

2. The assembly according to claim 1, wherein said housing has top wall, a bottom wall and a peripheral wall extending therebetween, said inlet extending through a first lateral side of said peripheral wall, said outlet extending outwardly through a second lateral side of said peripheral wall.

3. The assembly according to claim 1, wherein said suction hose has a first end and a second end, said first end having a first coupler attached thereto, said first coupler engaging said inlet such that said pump creates suction in said suction hose, said second end having a screen coupled thereto.

4. The assembly according to claim 3, further including:
a screen positioned on said suction hose; and
said pressure hose has a first end and a second end, said first end of said pressure hose having a second coupler coupled thereto, said second end having a valve coupled thereto, said second coupler engaging said outlet such that said pump creates pressure in said pressure hose, said pump urging said fluid into said pressure hose when said screen is positioned within said fluid.

5. The assembly according to claim 2, further including a power supply coupled to said housing, said power supply being electrically coupled to said actuator, said power supply comprising a cord extending outwardly from said peripheral wall, said cord having a distal end with respect to said housing, said distal end having a plug electrically coupled thereto, said plug being configured to be electrically coupled to said vehicle.

6. A fluid siphoning system comprising:
a container containing a fluid;
a vehicle having a fuel tank;
a housing having top wall, a bottom wall and a peripheral wall extending therebetween;
a pump positioned within said housing, said pump having an inlet and an outlet, said inlet and outlet extending outwardly through said housing, said inlet extending through a first lateral side of said peripheral wall said outlet extending outwardly through a second lateral side of said peripheral wall;
a suction hose having a first end and a second end, said first end having a first coupler attached thereto, said first coupler engaging said inlet such that said pump creates suction in said suction hose, said second end having a screen coupled thereto, said screen being positionable within said container or said fuel tank to draw said fluid through said suction hose; and
a pressure hose having a first end and a second end, said first end of said pressure hose having a second coupler coupled thereto, said second end having a valve coupled thereto, said second coupler engaging said outlet such that said pump creates pressure in said pressure hose, said pump urging said fluid into said pressure hose when said screen is positioned within said fluid, said valve being actuatable to release said fluid from said valve into said container or said fuel tank;
an actuator coupled to said housing, said actuator being electrically coupled to said pump, said actuator actuating and de-actuating said pump, said actuator being positioned on said top wall; and
a power supply coupled to said housing, said power supply being electrically coupled to said actuator, said power supply comprising a cord extending outwardly from said peripheral wall, said cord having a distal end with respect to said housing, said distal end having a plug electrically coupled thereto, said plug being configured to be electrically coupled to said vehicle.
